(19) United States
(12) Patent Application Publication
(10) Pub. No.: US 2007/0164192 A1
(43) Pub. Date: Jul. 19, 2007

(54) Ice Molding Container and Method

(76) Inventors: William Holden, Durango, CO (US); Peter Jon Campbell, Durango, CO (US)

Correspondence Address: KILE GOEKJIAN REED & MCMANUS, 1200 NEW HAMPSHIRE AVE, NW, SUITE 570, WASHINGTON, DC, 20036, US

(21) Appl. No.: 11/624,506

(22) Filed: Jan. 18, 2007

Related U.S. Application Data
(60) Provisional application No. 60/759,584, filed on Jan. 18, 2006.
(60) Provisional application No. 60/746,691, filed on May 8, 2006.

(51) Int. Cl. B28B 7/20; B41B 11/54

(52) U.S. Cl. 249/98; 249/170

(57) ABSTRACT

The present invention is directed to a personal ice molding container that has an opening for filling and pouring of formed ice. The molding container has two molding halves that each have a plurality of compartments for freezing liquid into ice. The two molding halves are held together to hold the liquid in the compartments. The ice molding container has an opening to create a water-tight seal during freezing. The opening can be selectively sealed and, when open, allows for dispensing of the formed ice.

### PROVISIONAL PRIORITY CLAIM

This application relates to and claims priority based on Provisional Application Ser. No. 60/759,584, filed Jan. 18, 2006, entitled “Ice Cube Molding Bag and Method” and Provisional Application Ser. No. 60/746,691, filed May 08, 2006, entitled, “Ice Cube Molding Pod”, the disclosures of each of the provisional applications are incorporated herein by reference as though set forth at length.

### BACKGROUND OF THE INVENTION

This invention relates to a method and apparatus for facilely forming discrete components of ice for personal use. More particularly, this invention relates to a method and apparatus for forming personal use ice units in various solid shapes and configurations.

In the past, ice cubes have been traditionally formed in metal or plastic trays by fitting the trays with generally vertical separation walls and filling the trays with water. The trays are then place on a flat surface within a freezer unit. Often, however, such trays have the disadvantages of being awkward to handle and being difficult to avoid spilling during transfer from the water source to a freezer. Further, ice trays must generally lay flat in a freezer. Moreover, ice trays are open and are therefore subject to contamination with particulate matter or airborne tastes within the freezer compartment.

Other types of trays have been used to minimize, for example, contamination from the freezer environment by use of covers, for example, sliding covers that cover the entire tray. Such trays have several limitations. The trays must still lay generally flat in a freezer for the water to flow and be properly distributed among the cube compartments. Further, such trays are not air tight and thus allow for spilling of the liquid out of the tray or the contamination of the ice with matter or tastes in the freezer compartment. In addition, the variety of ice shapes is limited by the need to have at least one flat surface as the top of liquid freezes.

Ice in a cube or solid rectangular form, while being relatively easy to form, does not provide an optimal heat transfer function in use. In this, ice within a container that is functioning to cool a liquid within the container would provide more surface contact with the fluid if the ice cubes were spherical instead of solid squares or rectangles. A sphere maximizes the exposed surface area and increases spacing between spheres. It has been known to form personal use ice into spheres but previously known systems involve a filling tube for each spherical unit or other complicated ice forming arrangements as water will not maintain a spherical shape in liquid form.

In view of limitations in known systems, it would be desirable to provide a personal use method and apparatus for forming spherical or other geometrically shaped ice units for personal use that would be airtight and flexible that does not have to lay flat in a freezer for proper formation of ice, is easy to fill and avoid spilling during transfer from a water source to the freezer, resists spilling, resists contamination from other items in the freezer, and can form unique and various ice three dimensional shapes from a liquid.

### BRIEF SUMMARY OF THE INVENTION

The present invention is directed to an ice molding container that has an opening, or mouth, for filling with liquid and forming spherical or other three-dimensional shaped ice. Ice can be made with the container in any reasonable position and the container does not have to lay flat in a freezer. The container has a water-tight seal to prevent leakage and the entry of undesirable foreign flavors and/or matter into the forming ice.

In different embodiments of the invention, the molding container is made of molding halves made of material flexible enough to release the ice. In one embodiment of the invention, added material is used to provide structure to keep the molding halves together during freezing. In various embodiments of the invention, the molding container can make ice in different shapes, sizes and configurations.

### BRIEF DESCRIPTION OF THE DRAWINGS

FIG. 1 illustrates an ice molding container with a zip mechanism in a semi-open configuration operable to be filled with a liquid such as water;

FIG. 2 illustrates a partially open configuration of the embodiment of the invention shown in FIG. 1;

FIG. 3 illustrates the embodiment of FIGS. 1-2 in its natural, closed state for making ice;

FIG. 4 illustrates an alternative configuration for the ice molding container and a zipping element;

FIG. 5 illustrates a partially open configuration of the embodiment of the invention shown in FIG. 4.

FIG. 6 illustrates alternative shapes of ice and configurations;

FIG. 7 illustrates an alternative embodiment of an ice molding bag in its natural state for making ice;

FIG. 8 illustrates an ice molding bag open to refill with liquid or pour formed ice from the bag; and

FIG. 9 illustrates an ice molding bag with an additional material to help keep the two halves of the mold together for fluid separation of discrete spherical ice units for freezing.

### DETAILED DESCRIPTION

The following description will discuss in detail the present invention with reference to the accompanying drawings and illustrative embodiments of the invention. In the drawings, the first digit of a reference number identifies the drawing in which the reference number first appears and identical reference numbers indicate identical elements. The embodiments described below are provided by way of example, and not limitation. It would be apparent to one skilled in the art that this invention can be used in a variety of other configurations, arrangements, and applications.

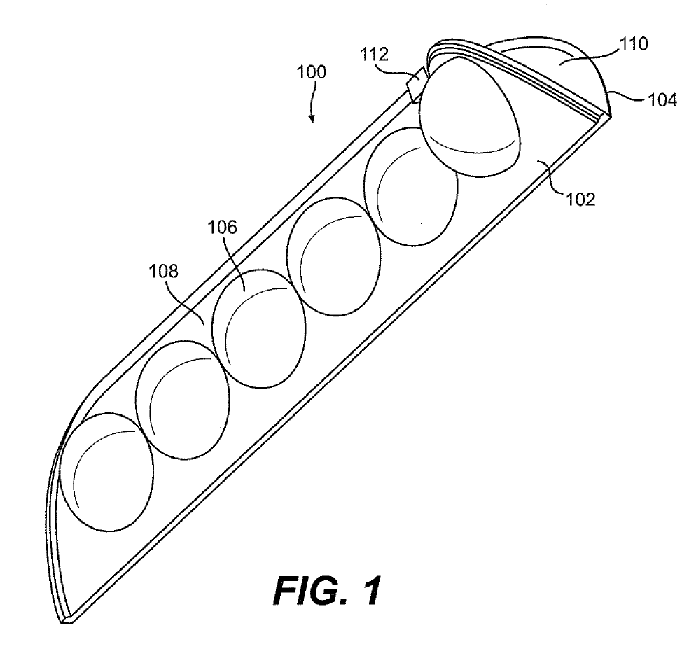

FIG. 1 illustrates one embodiment of the invention. Ice molding pod 100 is shown having two molding halves 102 and 104 with one row of hemi-spherical compartments 106 for forming discrete spherical ice balls. Although the current invention is often referred to as a “bag” or “pod”, no particular shape or degree of thinness or firmness is implied. An ice molding container according to the present invention can be flexible depending on the material used to make molding halves 102 and 104 or can be relatively rigid. Preferably, enough flexibility is present to allow the material to release the ice and sturdy enough to form a vessel capable of holding water in a three dimensional configuration.

The molding halves can be (but are not limited to) rubber, silicone, or plastic. Molding halves 102 and 104 have a plurality of hemi-spherical compartments 106 for ice to form. Once filled, the water will flow into compartments 106. Compartments 106 from each of molding halves 102 and 104 are complementary and, together, form a container for the formation of ice. In FIG. 1, compartments 106 are shown in a half-spherical shape. Alternative shapes can be used depending on the shape of the ice desired. The spaces 108 between hemi-spherical compartments 106 of each of molding halves 102 and 104 are held together, thus preventing water from collecting and freezing at locations 108, allowing ice to form only in the shapes of compartments 106. The molding halves 102 and 104 can be held together for freezing by the inherent properties of the molding material and surface tension between flat abutting surfaces of the mold 108. Additional material can assist to provide structure or force to keep the two halves together during freezing for a reliable spherical product. Such means that are useful to hold the halves of the container together include the inherent attraction between molding halves, the stiffness of the molding halves, surface water tension, or an additional element such as embedded magnetic material or cooperating lips around each hemi-sphere. Spaces 108 can be held together by the shape and nature of material of the ice molding bag, once sealed or by other means as discussed below. In the embodiment shown in FIG. 1, the pod is held closed and spaces 108 held together in part by the presence of zip mechanism 112. The property of being held together at spaces 108 has the added advantage of allowing the ice molding pod to be placed in a position in the freezer compartment on a non-flat surface. As the water collects in and fills compartments 106 and is kept out of spaces 108, the pod can be placed in the freezer in any position and will not disturb the distribution of water, even when on a non-flat surface.

Opening 110 is shown in a semi-open position. In this position, opening 110 allows for filling the container with water. In a sealed position, opening 110 becomes a water tight seal. This seal can be in the form of contours, a zip-lock, a folded seal, or other acceptable means of making a water-tight seal. In this embodiment, a zip mechanism 112 is shown. Zip mechanism 112 serves to open the bag 100 along its length to allow for filling with liquid and dispensing of ice. The zip mechanism has the added advantage of acting as a water-tight seal to prevent the spilling of liquid out of the molding pod or the contamination of the forming ice. Although this embodiment shows a zip mechanism 112, one of skill in the art would recognize additional means to seal the molding pod including contours, a folded seal, or other acceptable means of making a water-tight seal. FIG. 1 illustrates a semi-open configuration of the embodiment of the invention with an optional zip mechanism. Zip mechanism 112 is shown here in a partially open configuration where it is being opened. In this configuration, water may be filled into molding pod 100 to a predetermined volume which flows and collects into compartments 106 for freezing. Once the pod is pushed closed and sealed, excess water can be released and the pod sealed. Although zip mechanism 112 is shown along a majority of the circumference of bag 100, one in the art would understand that zip mechanism 112 may go a shorter distance around the circumference. Once filled, the zip mechanism may be closed.

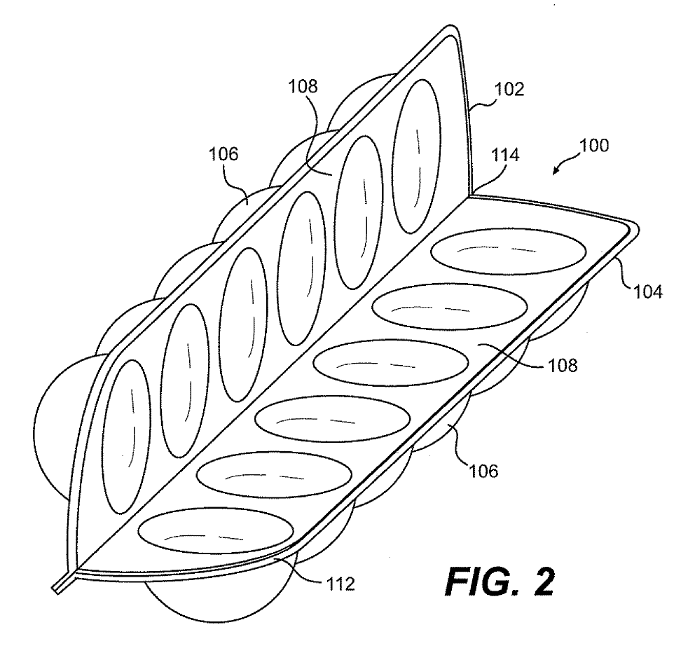

FIG. 2 illustrates an additional alternative open configuration of the embodiment in FIG. 1. Ice molding pod 100 is shown having molding halves 102 and 104 connected along a hinge 114. Each of molding halves 102 and 104 has a plurality of compartments 106, which are complementary to each other for the forming of ice. Spaces 108 between compartments 106 can be held together in this embodiment by the stiffness of the material used in forming molding halves 102, 104, by zip mechanism 112 or by tension at hinge 114 favoring a closed position. Although the seam between molding half 102 and molding half 104 is shown as a hinge 114 in this embodiment, one of skill in the art would understand tat a hinge-type part is possible when the molds are made of a stiff material such as plastic but may not be desirable in other applications.

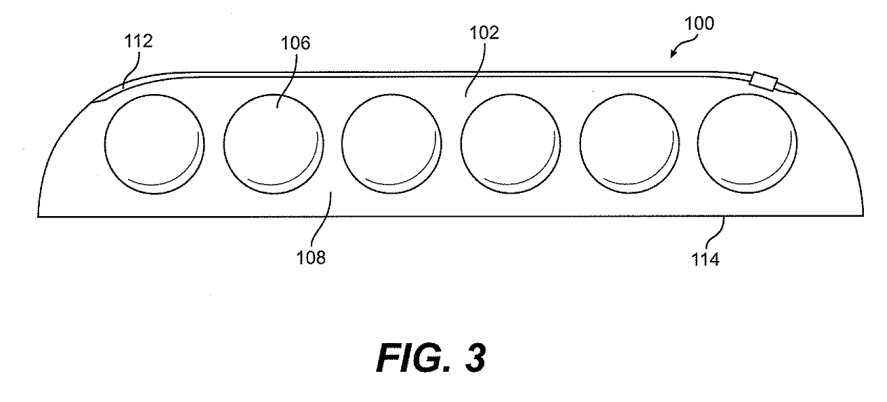

FIG. 3 illustrates a closed configuration of the embodiment of the invention shown in FIG. 1 in its natural state for forming ice. Ice molding bag 100 is shown having molding halves 102 and 104 (molding half 104 not shown) joined by a hinge 114 and zip mechanism 112. Zip mechanism 112 if fully closed and serves as a means to seal the molding pod and to hold the molding halves together during freezing.

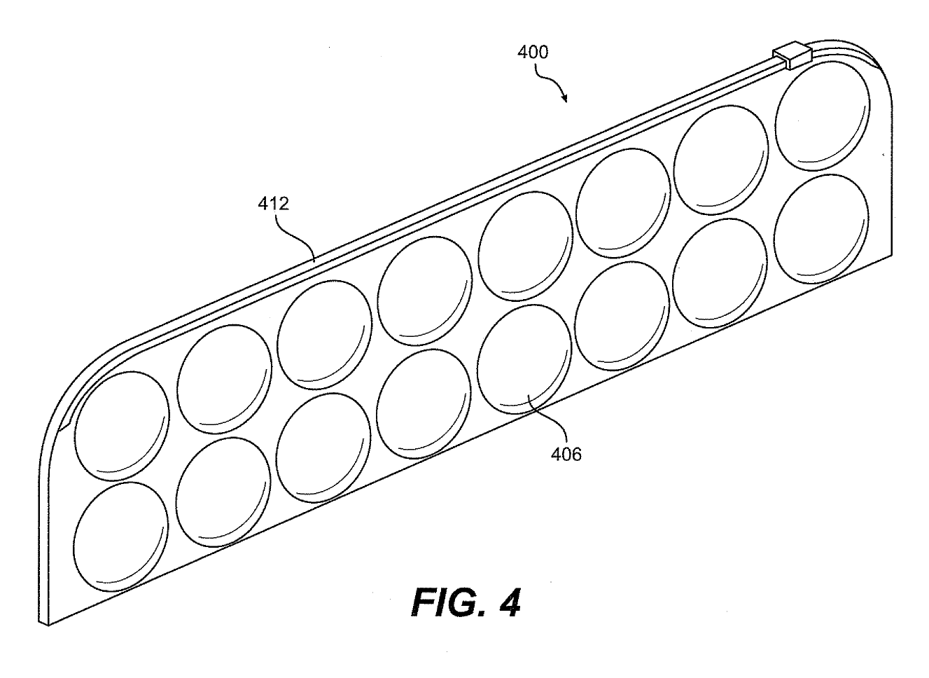

FIG. 4 illustrates an alternative configuration for the invention. Instead of completely opening, this molding pod opens similar to that of a “pouch”. Zipper enclosure 412 extends generally along one side of bag 400. In addition, two rows of compartments 406 are shown. One of skill in the art would understand that any configuration of rows or shapes of compartments 406 is possible. Similarly, depending on the stiffness of the material of the molding halves, the sealing enclosure may extend across a smaller or larger distance.

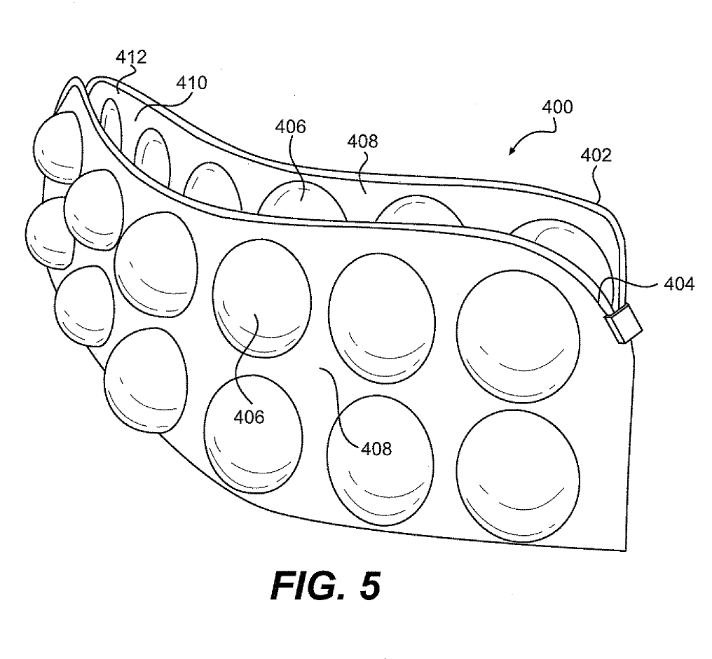

FIG. 5 illustrates a partially open configuration of the embodiment of the invention shown in FIG. 4. Ice molding pod 400 is shown having molding halves 402 and 404. Each of molding halves 402 and 404 has a plurality of compartments 406, which are complementary to each other for forming of ice. Spaces 408 between compartments 406 are held together as discussed during freezing. In this embodiment opening 410 is shown in an open position. In this position, opening 410 allows for filling the container with water. In a sealed position, opening 410 becomes a water tight seal. Opening 410 is shown generally across one side of the molding “pouch” and, when sealed, serves to seal and keep the molding halves together. Additional material such as plastic around the remaining ¾ of the mold's edges may provide some rigidness along the edges and help keep the halves together.

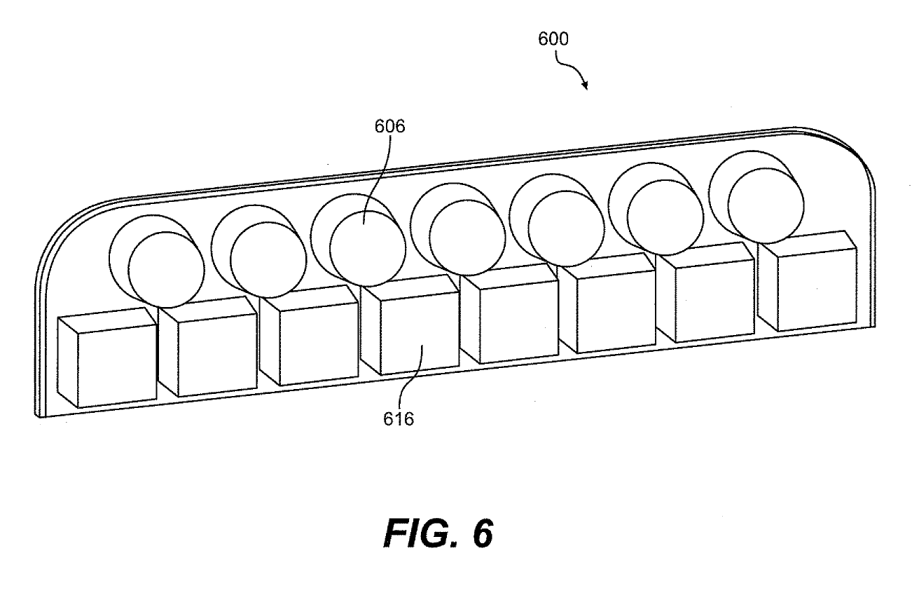

FIG. 6 illustrates alternative shapes of ice and configuration. Ice molding pod 600 is shown with compartments 606 and 616 in different shapes. Any of the openings and closures discussed are possible.

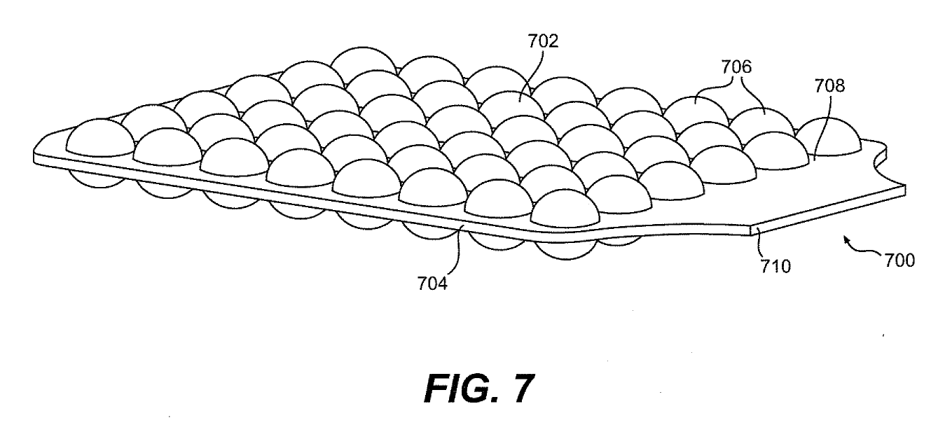

FIG. 7 illustrates an alternative embodiment of the invention as an ice molding bag in its natural state for making ice. In this, ice molding bag 700 is shown with two molding halves 702 and 704. An ice molding bag according to the present invention can be quite flexible depending on the material used to make molding halves 702 and 704 or can be quite rigid. Preferably, enough flexibility is present to allow the material to release the ice and sturdy enough to form somewhat of a vessel capable of pouring formed ice. Each molding half has a plurality of compartments 706 for the forming of ice and spaces 708 between the compartments.

Opening 710 is shown in a closed position. In this sealed position, opening 710 serves as a water-tight seal. This seal can be in the form of contours, a zipper, a folded seal, or other acceptable means of making a water-tight seal.

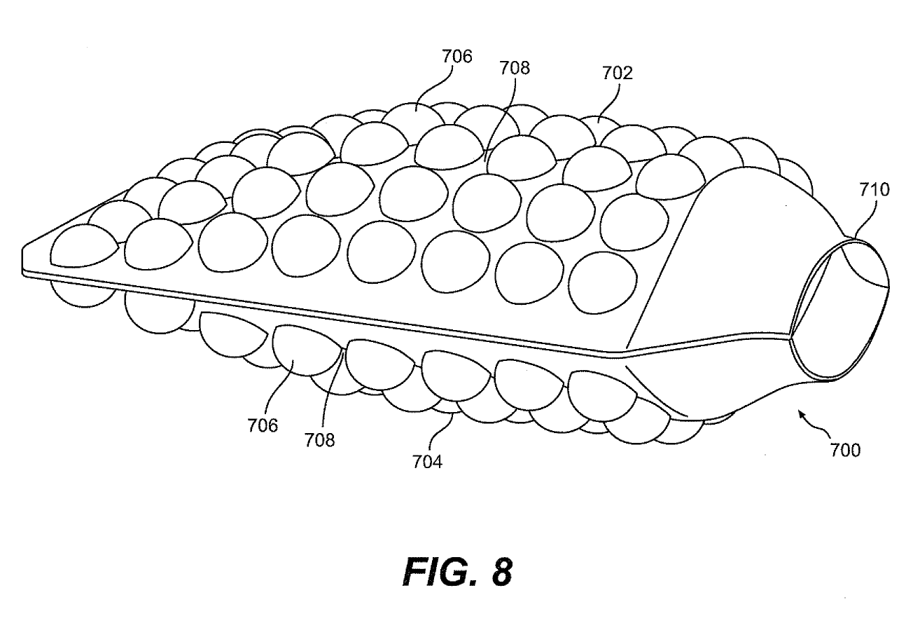

FIG. 8 illustrates an ice molding bag open to refill with liquid or to pour out the formed ice. This figure discloses an embodiment similar to that of FIG. 7, in an open position, for filling or for pouring of formed ice. Ice molding bag 700 is shown with molding halves 702 and 704. Molding halves 702 and 704 have a plurality of compartments 706 for ice to form. In a closed position compartments 706 of opposing halves 702 and 704 are complementary and form a plurality of compartments for the ice to form in a spherical shape. Spaces 708 between compartments 706 are again shown. The spaces 708 between compartments 706 are held open when the ice molding bag is in an open configuration. Once closed, spaces 708 are held together, preventing water from collecting and freezing at locations 708 and allowing the ice to form in compartments 706. Opening 710 is shown in an open position. In this configuration, water may be poured into the ice molding bag in a predetermined volume sufficient to fill compartments 706, but not to overflow into spaces 708. Once closed, the liquid flows into compartments 706 and freezes in the shape of compartments 706, here, a spherical shape. Once frozen the molding bag may be opened again to release the ice from the molding compartments and to allow for pouring of the ice out of opening 710.

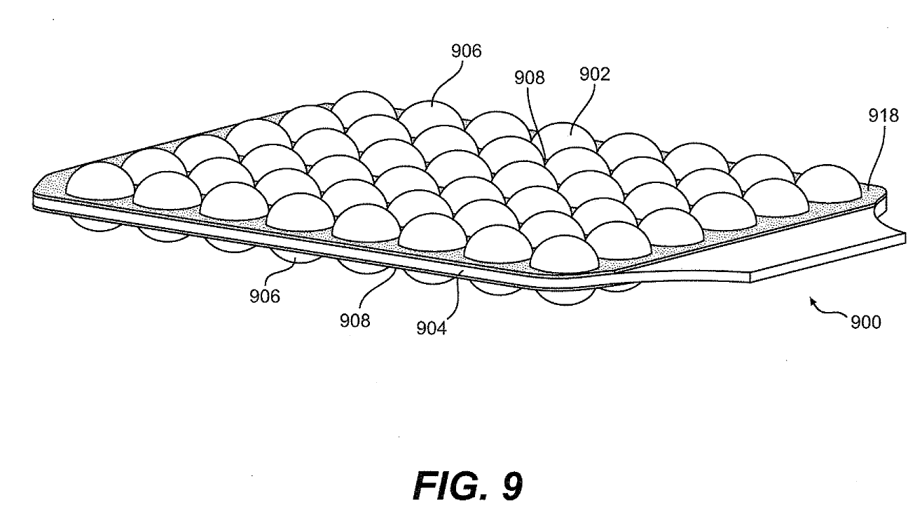

FIG. 9 illustrates an ice molding bag in one embodiment with additional material to help keep the two halves of the mold together for freezing. Ice molding bag 900 is shown with molding halves 902 and 904. Each of molding halves 902 and 904 have a plurality of compartments 906 for ice to form. In a closed position, compartments 906 of opposing halves 902 and 904 are complementary and form a plurality of compartments for ice to form, as shown. Spaces 908 between compartments 906 are shown held together to prevent ice from forming in spaces 908. In this embodiment, additional material 918 is employed to hold together molding halves 902 and 904 and, specifically, to keep together spaces 908, thereby preventing water from freezing at locations 908 and only in compartments 906. The additional material can be (but is not limited to) plastic, rubber, thin stainless steel, wire forms, or flexible magnetic material. The additional material can be on the outside of the molding material or embedded into the molding material.

The foregoing embodiments were discussed for illustrative purposes by way of example only. A person skilled in the art will recognize that other configurations and arrangements can be used without departing from the spirit and scope of the invention. This invention can also be employed in a variety of other contexts. For example, this invention can be used with juices or other liquids, other than water. Further, various types of materials may be used for the mold body and for the resealable opening. Further still, the shapes of the molding halves may be varied according to the need for various ice shapes and sizes of molding bags. In one embodiment, one molding half may have a plurality of mold compartments with a second half having a relatively flat surface. The flat surface would still correspond with the spaces between the mold compartments, thus making an airtight container capable of forming ice in various mold shapes with one flat surface. As such the container need not be placed on a flat surface in a freezer. Such a container has the further advantages of the invention of being a convenient method to mold ice in an air tight container that is resistant to spilling and resists contamination. Thus, the present invention should not be limited by any of the above-described exemplary embodiments, but should be defined only in accordance with the following claims and their equivalents.

The various aspects were chosen and described in order to best explain principles of the invention and its practical applications. The preceding description is intended to enable others skilled in the art to best utilize the invention in various embodiments and aspects and with various modifications as are suited to the particular use contemplated. It is intended that the scope of the invention be defined by the following claims; however, it is not intended that any order be presumed by the sequence of steps recited in the method claims unless a specific order is directly recited.

### BRIEF SUMMARY OF FEATURES AND ADVANTAGES

The present invention is easy to use. The present invention is also easily manufactured at a low cost and is adaptable to a variety of needs for different sizes and shapes of ice. The subject invention is particularly useful for forming spherical personal ice units. The present invention is also convenient for use in situations where an ice tray may not conveniently lay flat in a freezer. The present invention allows for the convenient filling and transfer of liquid into the ice molding container from a water source to a freezer without spillage. The present invention further resists flavors from other items and stray particulate matter in a freezer that might contaminate forming ice.

Further features, advantages, and embodiments are discussed above.

What is claimed is:

1. An apparatus for forming ice comprising:
a first molding half having a plurality of three-dimensional compartments configured to receive liquid into said plurality of compartments;
a second molding half having a plurality of three-dimensional compartments configured to receive liquid into said plurality of compartments, said plurality of compartments opposing and being configured to complement and be continuous with said plurality of compartments of said first molding half; and
means for selectively sealing said first molding half with respect to said second molding half, wherein said apparatus, being operable to be filled with liquid flowing into said plurality of compartments in said first and second complementary molding halves, and be sealed upon filling and allows for the freezing of the liquid in the shape of said plurality of three-dimensional compartments.

2. An apparatus for forming ice as defined in claim 1 and further comprising:
a hinge along one straight line between said first molding half and said second molding half, said hinge being naturally biased in a closed position.

3. An apparatus for forming ice as defined in claim 2 wherein:
said means for selectively sealing comprises a zip-lock along an edge between said first and said second molding halves, said edge being the remaining edge opposing said hinge.

4. An apparatus for forming ice as defined in claim 3 wherein:
said plurality of three-dimensional compartments is hemi-spherical, said apparatus forming ice in a spherical shape.

5. An apparatus for forming ice as defined in claim 4 wherein:
said first and said second molding halves comprise a single row of said plurality of three-dimensional compartments.

6. An apparatus for forming ice as defined in claim 5 wherein:
said first and said second molding halves comprise two rows of said plurality of three-dimensional compartments.

7. An apparatus for forming three-dimensional shaped ice comprising:
a first molding half having a plurality of compartments configured to receive liquid into said plurality of compartments;
a second molding half having a plurality of compartments configured to receive liquid into said plurality of compartments, said plurality of compartments being configured to complement and be continuous with said plurality of compartments of said first molding half said first molding half and said second molding half being united along at least one side;
a seal operable to close said first molding half with respect to said second molding half; and
means for holding said first and said second molding halves together, wherein said apparatus, being operable to be filled with liquid flowing into said plurality of compartments in said first and second complementary molding halves, is sealed and held closed upon filling and allows for the freezing of the liquid in the shape of said plurality of compartments.

8. An apparatus for forming and dispensing ice as defined in claim 7 wherein said means for holding said first and said second molding halves together comprises:
first and second molding halves formed with a rigid material that retains said first and second molding halves together once the periphery of said sealed mold compartment is sealed.

9. An apparatus for forming and dispensing ice as defined in claim 7 wherein said means for holding said first and said second molding halves together comprises:
a zip-lock uniting said first and said second molding halves along a majority of the periphery of said sealed mold compartment.

10. An apparatus for forming and dispensing ice as defined in claim 7 wherein said means for holding said first and said second molding halves together comprises:
a hinge uniting said first and said second molding halves, said hinge tending to hold said first and said second halves together.

11. An apparatus for forming and dispensing ice as defined in claim 7 wherein said means for holding said first and said second molding halves together comprises:
additional material coupled to at least one of said molding halves, said additional material providing structure to keep said first and second molding halves together during the freezing process.

12. An apparatus for forming and dispensing ice as defined in claim 11 wherein said additional material is magnetic material.

13. An apparatus for forming and dispensing ice as defined in claim 7 wherein:
said seal comprises a zip-lock to selectively seal said opening.

14. An apparatus for forming and dispensing ice as defined in claim 7 wherein:
said seal comprises a folded seal to selectively seal said opening.

15. An apparatus for forming and dispensing ice as defined in claim 7 wherein:
said plurality of compartments is configured to produce ice in a spherical shape.

16. An apparatus for forming and dispensing ice as defined in claim 7 wherein said plurality of compartments is configured to produce ice in a cubical shape.

17. An apparatus for forming and dispensing ice as defined in claim 7 wherein said first and said second molding halves are united along a majority of the periphery when the seal is not sealed.

18. An apparatus for forming ice comprising:
a first molding half having a plurality of three-dimensional compartments configured to receive liquid into said plurality of compartments;
a second molding half having a planar surface configured to oppose and abut said first molding half; and
means for selectively sealing said first molding half with respect to said second molding half, wherein said apparatus, being operable to be filled with liquid flowing into said plurality of compartments in said first molding halves, and be sealed upon filling and allows for the freezing of the liquid in the shape of said plurality of three-dimensional compartments.

19. A method for forming and dispensing shaped ice comprising:
providing a mold compartment having an opening and two molding halves having a plurality of mold compartments;
opening said mold compartment and said opening;
filling said mold compartment with liquid;
holding said two molding halves together;
sealing said opening;
placing said mold compartment in a freezing environment; and
removing ice from said molding compartment by opening said mold compartment.
